(19) United States
(12) Patent Application Publication
(10) Pub. No.: US 2011/0219683 A1
(43) Pub. Date: Sep. 15, 2011

(54) Plant, Vegetable and Herb Growing System

(76) Inventor: Donald J. Sutton Sutton, Pompano-Beach, FL (US)

(21) Appl. No.: 12/781,677

(22) Filed: May 17, 2010

Related U.S. Application Data
(60) Provisional application No. 61/179,356, filed on May 18, 2009.

(51) Int. Cl. A01G 9/02; A01G 13/02; A01G 25/00

(52) U.S. Cl. 47/31; 47/65.5; 47/20.1; 47/79

(57) ABSTRACT

The Plant Growing System “PGS” is a convenient and easy way to grow a high yield plant/vegetable/herb garden in a limited space within a self-contained watering and fertilization system. The PLANT, VEGETABLE AND HERB GROWING SYSTEM design allows plants to receive essential and critical nutrients through a self-contained irrigation and natural (worm) cultivating root system. With the PLANT, VEGETABLE AND HERB GROWING SYSTEM you can grow plants, herbs or vegetables indoor with UV lamps or outdoor in direct sunlight using either soil based growing methods or hydroponic growing methods. The PLANT, VEGETABLE AND HERB GROWING SYSTEM has built in pest deterrence techniques to keep unwanted animals from attacking the plants, herbs and vegetables. The PLANT, VEGETABLE AND HERB GROWING SYSTEM can be restricted to confined areas and used on apartment patios, small backyards, basements or small area with a yield of greater than 10 times of that of traditional gardening methods. Yield is 1:N-growing ratio, compared to traditional farming. For purpose of this provisional patent document, the system will be referred to PLANT, VEGETABLE AND HERB GROWING SYSTEM for plant growing system. The plant system has a weed control system for the containers. That blocks the sun light and prevents weeds from growing in the plant containers.

This application claims priority to the provisional Patent Application No. 61/179,356 filed on May 18, 2009

### BACKGROUND

### Plant Growing System Product Overview

The Plant Growing System “PGS” is a convenient and easy way to grow a high yield plant/vegetable/herb garden in a limited space within a self-contained watering and fertilization system. The PLANT, VEGETABLE AND HERB GROWING SYSTEM design allows plants to receive essential and critical nutrients through a self-contained irrigation and natural (worm) cultivating root system. With the PLANT, VEGETABLE AND HERB GROWING SYSTEM you can grow plants, herbs or vegetables indoor with UV lamps or outdoor in direct sunlight using either soil based growing methods or hydroponic growing methods. The PLANT, VEGETABLE AND HERB GROWING SYSTEM has built in pest deterrence techniques to keep unwanted animals from attacking the plants, herbs and vegetables. The PLANT, VEGETABLE AND HERB GROWING SYSTEM can be restricted to confined areas and used on apartment patios, small backyards, basements or small area with a yield of greater than 10 times of that of traditional gardening methods. Yield is 1:N-growing ratio, compared to traditional farming. For purpose of this provisional patent document, the system will be referred to PLANT, VEGETABLE AND HERB GROWING SYSTEM for plant growing system.

### Outdoor Use

The PLANT, VEGETABLE AND HERB GROWING SYSTEM is designed for vertical expansion and can be configured in a vertical build to N high. This system will allow for maximum utilization of space of plant, vegetable and herbs growth on a per Cubic foot area. The PLANT, VEGETABLE AND HERB GROWING SYSTEM can grow plant, vegetables and herbs year round, regardless of season, free of pesticides and fertilizers and eliminates weeding. The plant system will allow the user to regulate the Ultra Violet rays off of their plants from filtering from 1% to N%.

### Indoor Use

The plant growing system may also be used indoors with plant growing lights and cooling fans. The indoor system requires purchase of a reflective panel to retain growing light energy.

### Container Expansion System

The PLANT, VEGETABLE AND HERB GROWING SYSTEM has multi-plant containers. Initial system configuration is X size and contain # of containers. Containers can be added (1 to N) depending on available space. Space requirement are from 1 foot X 1 foot to N foot XX foot.

### Adaptable Irrigation Filtration System

The PLANT, VEGETABLE AND HERB GROWING SYSTEM can utilize several different irrigation filtration systems. The irrigation filtration system is easily adaptable for spray, drip, pot stake, mirco sprinklers or in-ground irrigation and can operate manually, work on a timer, or with an automatic control system that will turn the irrigation system on automatically based on the soil and atmospheric conditions. The IFS drip system is the most effective and efficient for conserving water and plant nutrients and can be expanded by connecting additional systems up to N size. There is a nutrient reservoir will inject nutrients into the drip system. The Plant growing system will eliminate the need for the user to manually water their plants and vegetables.

The holes in the bottom of the container can have a pipe connected to reclaim the water. The water will drain to the bottom of the container and the excess water will flow out a connected pipe to a reservoir ad be recycled. These pipes are connected together and drain in to a reservoir where the water can be reused. This process will be used in areas that have limited water supply. This process will also allow for the recapture of valuable soil nutrients.

### SUMMARY OF THE INVENTION

### How The Plant Growing System Allows User to Grow more Plants, Vegetables and Herbs per Cubic Foot

The natural self-contained closed loop, Plant Growing System allows for plants to be grown vertical and makes it easy to maintain a garden. By having the plants grow from the containers this minimizes the weeding process. The screens over the whole keep the worms in and the weeds out. The PLANT, VEGETABLE AND HERB GROWING SYSTEM solves the space requirements with the PLANT, VEGETABLE AND HERB GROWING SYSTEM. For people who live in apartment or condominiums or controlled communities and do not have a back yard to grow a garden the PLANT, VEGETABLE AND HERB GROWING SYSTEM allows for plant to grow vertically on their porch or balcony or in their house. The PLANT, VEGETABLE AND HERB GROWING SYSTEM can be used for commercial fanning as well allowing for a 1 to N additional yield per acre for growing crops. The PLANT, VEGETABLE AND HERB GROWING SYSTEM is a compact system allowing the users to grow plants up to N feet tall hanging from support beams.

### Grow Plants Year Round

The plant system can work indoors with a plant light or outside in a green house during the cold winters or during the hot summers. There is a netting system that will keep the flying insects, birds and other animals away from destroying the plants. The planting system will allow the user to grow. The system will support the use of Hydroponics plant growing. This automatic soil monitoring system may transmit the soil condition wireless to a remote Computer work station. A web cam may also be mounted so the user can watch his plants grow remotely

### Minimize the Number of Insects that will Attack your Plants

The plant growing system stops the insects from attacking the plants by having an oil based or pesticide based mote around the support beam from 1 to N support beams. The system is elevated off of the ground and is supported with 1 to N support legs. The support legs have and pesticide strip that wraps around the support leg preventing bugs and insects from climbing up the support beam to attract the plants, herbs and vegetables. There is a second security system for insects that is an oil-based mote that surrounds the support legs that will prevent insects from climbing to the plants, herbs and vegetables. By keeping the insects off of the vegtibles and herbs there is no need to spray the plant with harmful pesticides.

### Minimize the Number of Animals that will Attack your Plants

The netting around the system will keep the insects, pests and other animals away from eating the plant and vegetables. The netting still allow for the sun and rain to penetrate the plants.

### Protect you Plant from the Hot Sun and Grow Plants out of Season

To control the outside temperature there is a sun screen or UV ray cover to allow the user to adjust how much sunlight that plants will receive this will allow for plants and vegetables to be grown out of season. The UV ray cover will drop the outside temperature. The system will have a mist system that will also assist in dropping the outside temperature. By dropping the outside temperature this will allow the user to grow plant, vegetables and herbs out of the normal seasons. In the multi system Container Apparatus the irrigation the drip, pot stake, micro sprinklers irrigation allows for a controlled amount of water to be feed to the plants and vegetable and herbs and conserve water and plant and vegetable nutrients. When the system is used indoors there is a pan that will fit under the bench to catch the excess water from hitting the flooring the pan will have a pipe allowing the water to flow in to a reservoir. The plant growing system will allow plant to be watered with an irrigation system with a timer or with out a timer. The irrigation will allow for plant and vegetable and herb fertilizer, plant food, or other nutrients to be injected into the irrigation system. The ultraviolet ray screen will filter up to 95% of the sun light.

### Control Module Monitors Soil Conditions

The control module (CM) is designed to eliminate the need to manually test the soil conditions of your plants and the atmosphere conditions it can identify if the soil is getting too much or too little water and other nutrients. CMS applies water and nutrients as needed to keep the balance for optimal growth and is powered by photo cells, battery or standard household electric. The CMS receives data and is transmitted and stored in a central database and tracked by sensor for analysis of the health of the plant and to determine the crop yield. The system will have a webcam that will allow the user to watch their plants grow remotely.

These and other features of the present invention are more fully set forth below.

### BRIEF DESCRIPTION OF THE DRAWINGS

Drawings—Figures:

FIG. 1—Outdoor Plant Growing System

FIG. 2—Indoor Plant Growing System

FIG. 3—Indoor and Outdoor Signal Pole Plant Growing System

FIG. 4—Multi Plant Container and Lid With and How Plants Will Grow In The Container

FIG. 5—Plant Seed Starter pots Flat Cell, Manure pots and peat moss

FIG. 6—Worm Farm and Composting System

FIG. 7—Bee Hive for Pollination

FIG. 8—Container to grow plants with drainage and liquid recapture system

FIG. 9—Support stand for container and support poles

FIG. 10—Weed Control System

### DRAWINGS—REFERENCE NUMERALS

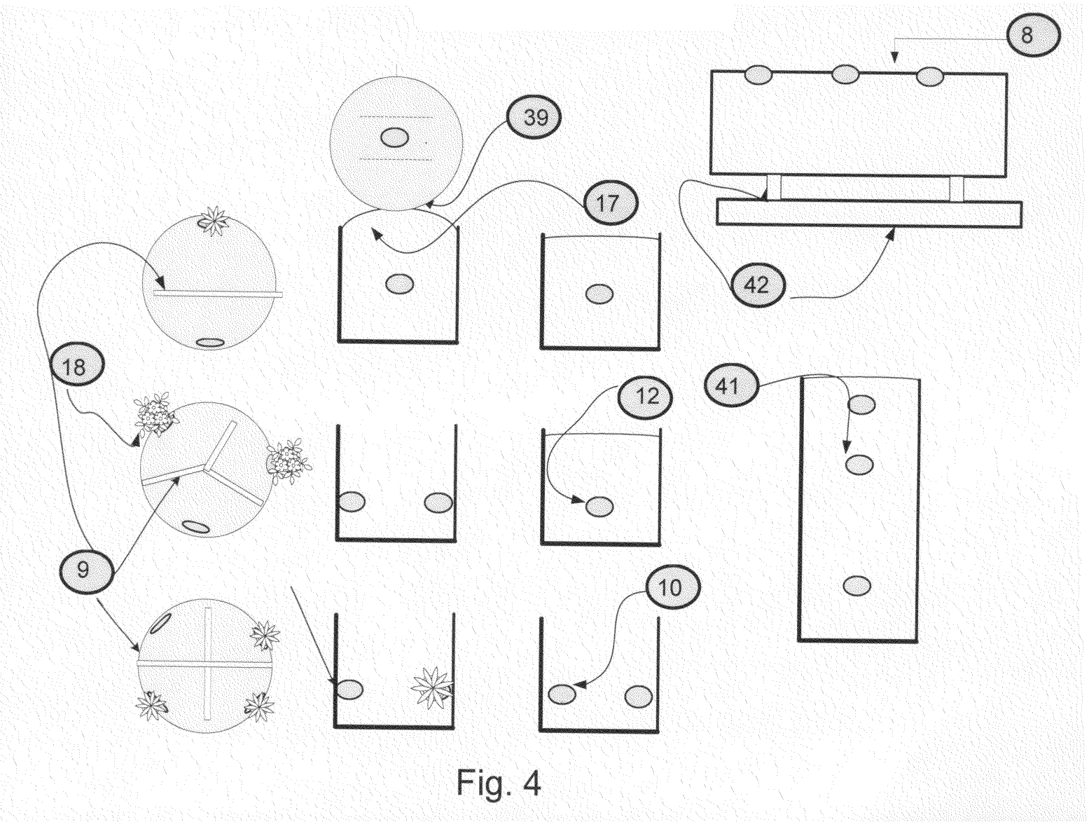

1—FIG. 4 Plant seeds are started directly in the plant Container Apparatus will plant soil. You place potting soil in the pot or cell flats and plant the seed form the surface to N deep depending on the plant type.

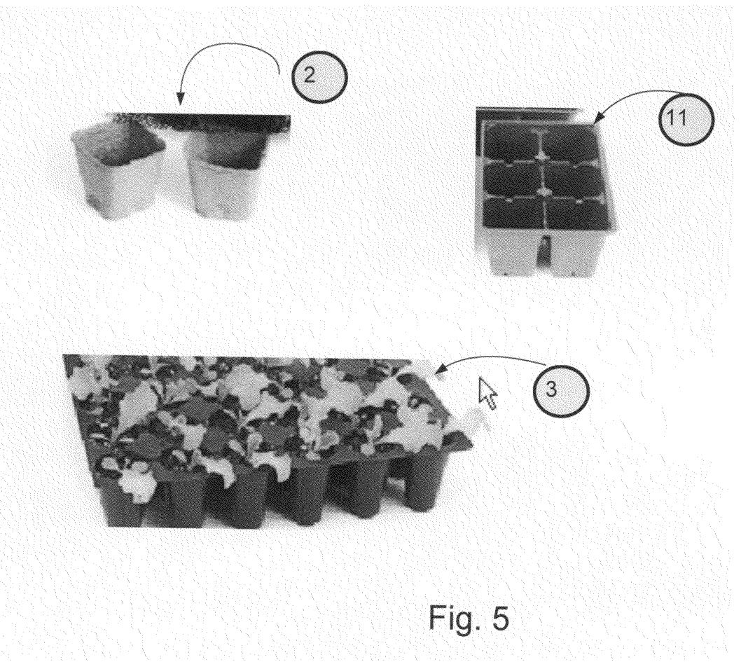

2—FIG. 5 Plant seeds can be started in manure based pots that are Eco-friendly and are 100% biodegradable. You place potting soil in the manure base pot and plant the seed form the surface to N deep depending on the plant type. Once the plant, vegetable or herbs are large enough they are transplanted in the whole pot to prevent root shock.

3—FIG. 5 Plant seeds are started in small pot ½×½ inch to N×N size. The pots are filled with soil. The seed will be placed on the surface to N inches deep.

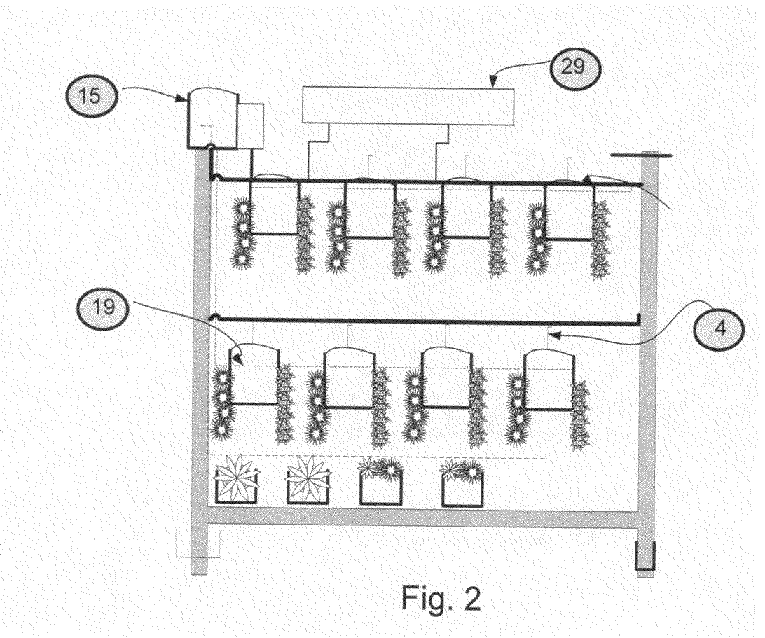

4—FIG. 2 The plant Container Apparatus can he hung from the support beams or grown on the bench The support beam runs the length of the bench and will be able to support form 1 to N Plants on the pole that is connected by the 2 support beams.

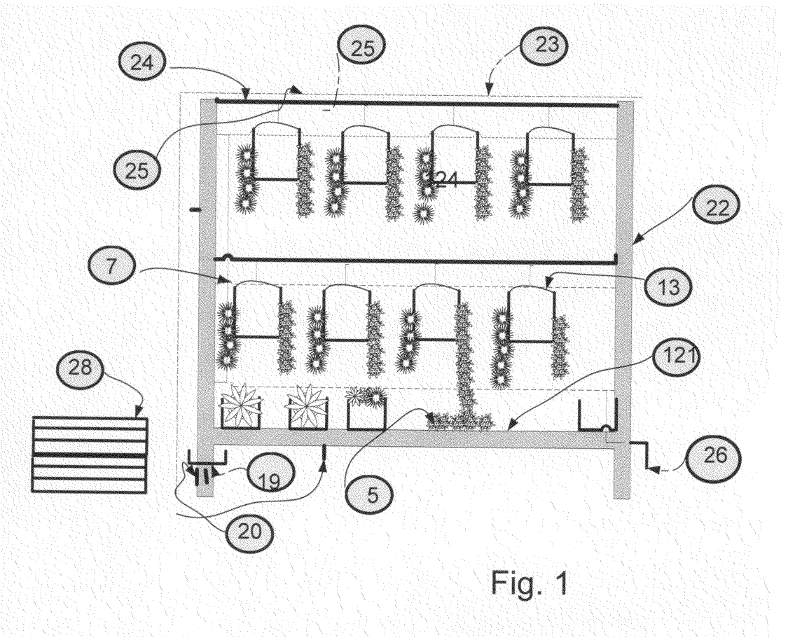

5—FIG. 1 Plant Container Apparatus that is hung will allow for the vines to grow down and the plant leaves or vegetables and herbs to grow downward.

6—FIG. 4 The hanging Container Apparatus makes it easy to prune the plant and pick the fruits and vegetables and herbs and to keep the insect off of the plants.

7—FIG. 1 The hanging plant Container Apparatus prevents insect from climbing up from the ground to spoil the plant, vegetables and herbs.

8—FIG. 4 The plant Container Apparatus allow for multiple plant to be grown in the same space. The dividing walls allow the same plant family or different plants to be grown in the same container. Worms are placed inside the plant container and can travel though small holes on the divider.

9—FIG. 4—Dividing wall of plant container apparatus allow plant families to be separated

10—FIG. 4—Plant Container Apparatus can house from 1 to N plants, vegetables and herbs.

11—FIG. 5—Plants seeds can be started in cell flats or pots with plant soil that are from ½×½ inch to N×N size. The pots are filled with soil. The seed will be placed on the surface to N inches deep. Once the plant, vegetable or herbs grow large enough in the cell flat or pot they are transplanted into the plant Container Apparatus. Biodegradable cloth placed around the root of the plant to keep the soil and nutrients from falling out.

12—FIG. 4—Hole on the side and bottom of the Container Apparatus so they can be stacked up vertically to maximum the growing space per cubic foot. Small holes on the lid with screening to keep the worms from escaping this also allow for the plants to receive nutrients

13—FIG. 1 The plant growing system has a irrigation dip system that regulates the amount of water to each plant family.

14—FIG. 2—The irrigation system can dispense water as needed to each plant and conserve water.

15 FIG. 2—The plant growing system has an independent water reservoir to irrigate the plant on a drip bases. The plant system has a nutrient reservoir to inject plant, vegetable and herb nutrients into the plant Container Apparatus. Water reservoir is for using the PGS inside or where there is no water supply available outdoors in a rural area.

17—FIG. 4—The plant Container Apparatus will have a handle that will allow it to be hung from the systems support beam or hung independent to the plant growing system.

18—FIG. 4—System allows for the plant to grow from the side and bottom of the plant Container Apparatus.

19—FIG. 1—Shows a mote on the support beams near the ground. The mote can be filled with pesticides to prevent insect climbing up to the plants, vegetable and herbs. This will eliminate the need to spray pesticides on the plants

20—FIG. 1—The monitor trap for insect pests. Devices will be placed around the support polls. The sticky traps attract insects by color. Hang the trap lure inside to monitor and trap these pests. Trap remains sticky all season, even in rain, or until completely coated with insects or dust

21—FIG. 1—Bench will be used to grow the seedling and the starter plants for the system manure based starter pots, cell flats and other plant. The bench will have the irrigation system to allow the correct water and nutrient flow

22—FIG. 1—Structure will have from 1 to N support beams

23—FIG. 1 Structure will support from 1 to N to hang plants.

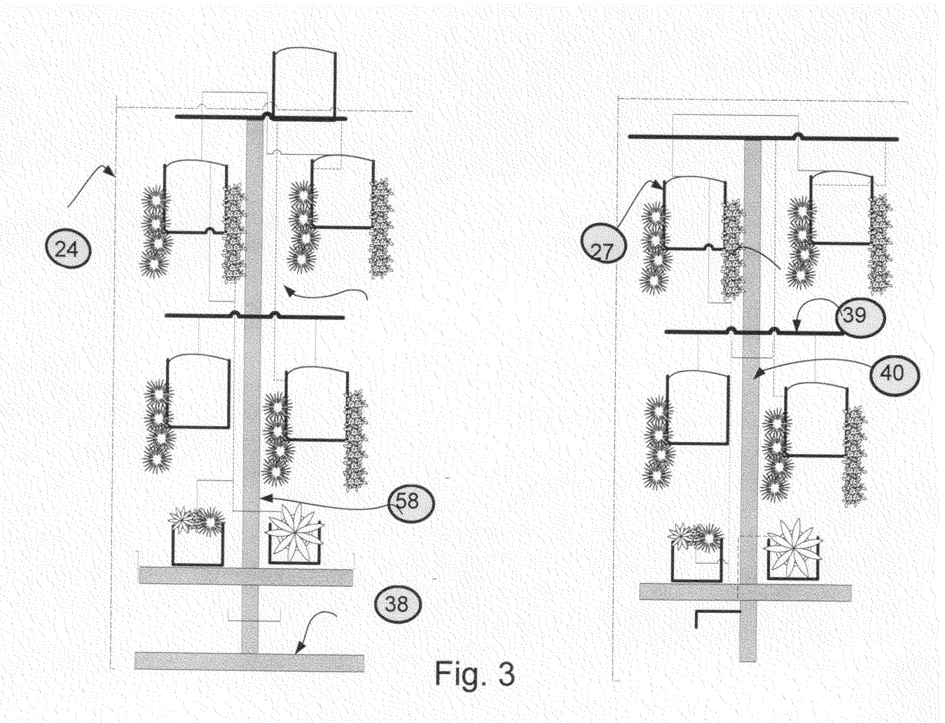

24—FIG. 3 Ultra Violet “UV” rays with adjustable and removable UV screen. Prevent plants from getting to much sun and allowing them to grow out of season Plants and vegetables UV rays by applying screen cloth. This screen will also prevent flying insects form attacking the plants. Fine wrap around netting will keep insects, animals out of the plants or Green House cover for winter growing

25 FIG. 1—Irrigation mist reduce temperature for plant to grow out of season or in different claimants. The mist will also provide nutrients to the plants.

26 FIG. 1—The irrigation system filter removes any bacteria and other chemical that may be harmful to the plants, vegetables and herbs. Hydroponic systems will be connected to the fish tank to recycle water. Hydroponic systems will provide the nutrients from the fish by product to provide addition nutrients for the soil in the containers.

27 FIG. 3—Standard garden hose can be connected to the PLANT, VEGETABLE AND HERB GROWING SYSTEM or can be connected directly to city water or to a irrigation well that has a pump

28—FIG. 1—Worm farming tub provides castings for additional nutrients

29 FIG. 2—Cooling fans used for indoor PGS with plant growing light and reflective wrapper will contain the artificial sunlight. Their will be a support base at the bottom of the vertical post structure to house apparatus.

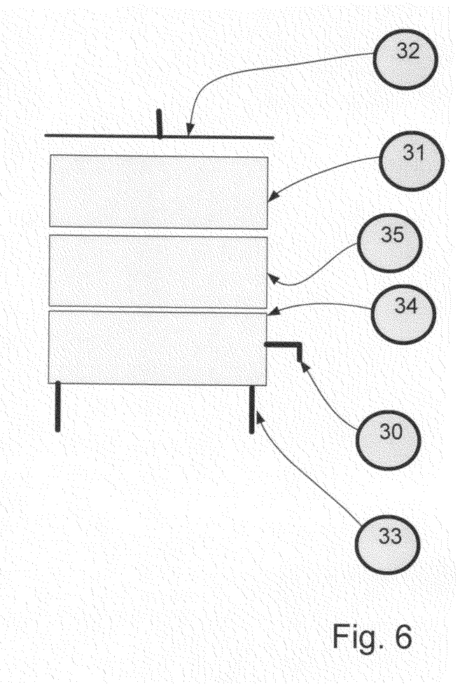

30—FIG. 6—Drain Pipe spigot for liquid fertilizer know as leachate or worm tea and a base for worm farm.

31—FIG. 6 Worm farm to recycle their vegetables and other foods.

32—FIG. 6 Plant container lid to with holes to keep the worms inside the plant container. Their will be screening to keep the worms from escaping. The lid will also be used for weed control

33—FIG. 6 Worm farms legs with pesticide mote and sticky strips to protect the worms.

34—FIG. 6—Worm farm producing worm Castings. Worm castings from the worm farm can be sprinkled on the surface of the soil around your plants. The plant growing systems worm farms castings are produced from recycled worm wastes, this allows for contributing to a cleaner, less polluted environment. Worms inside the Plant container will be producing worm casting that will promote the growth of the plants. Plants fertilized with worm castings are less likely to succumb to pest and diseases. Worms placed inside the plant container will be producing plant nutrients. The high level of essential nutrients in worm castings make it the perfect potting mix and plant food for all types of flowers and vegetables. The worms placed into the plant containers with a lid, this keeps the worms in a confined area. The lid also is used for weed control.

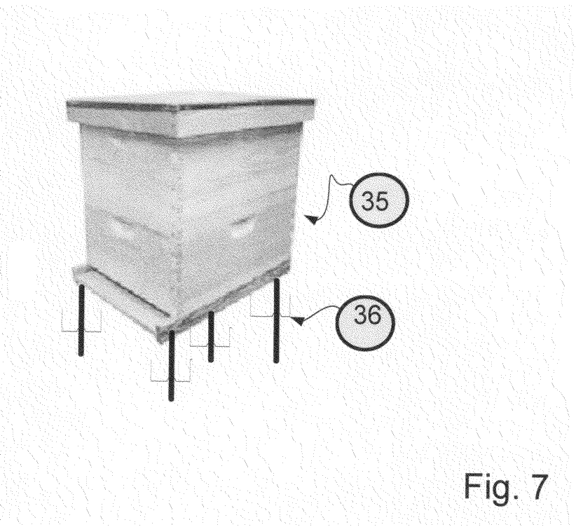

35—FIG. 7—Bee hive will be used for the pollination of the plants.

36—FIG. 7—Bee hive mote is filled with oil to prevent ants from attacking the hive.

37—FIG. 4—Plant container have a fine mesh netting lined inside to cover the water drain holes to prevent the worms from escaping. The hole at the bottom of the container is used to recapture the excess water.

38—FIG. 3 Support base that will stabilize the structure. Support straps that will anchor the system into the ground to prevent the structure from becoming unstable.

39—FIG. 3 and 3 Vertical support post attached to the horizontal support beams. This allow from 1 to N Plant container to be attached

40—FIGS. 1 and 3 Horizontal support beams are attached to the vertical Post. This allow from 1 to N Plant container to be attached

41—FIG. 4 Plant are placed in a tube from ½ in in diameter to N ft and N feet in length, this will allow for plants to grow without the weeds. This tub maybe paced on the ground by itself or suspended from the plant growing system.

42—FIG. 4 tubing is connected to the bottom of the container to reclaim the water used for the irrigation of the plants. Tubing maybe connected to the bottom or the sides of the container.

43—FIG. 11 Netting is placed over the VPGS that will control the sunlight and the tempter. The netting will also prevent insects from invading the interior. The netting will prevent insects from attacking the plants.

44—FIG. 11 there is a support beam that will extend out ward to allow the netting to extend away from the plants.

45—FIG. 11 The systems are modular and allow for a 2^{nd though Nth} floor to be laced between the systems. This allows for the maintenance of plants on the Nth levels.

46—FIG. 11 The system will have a surface to place plants.

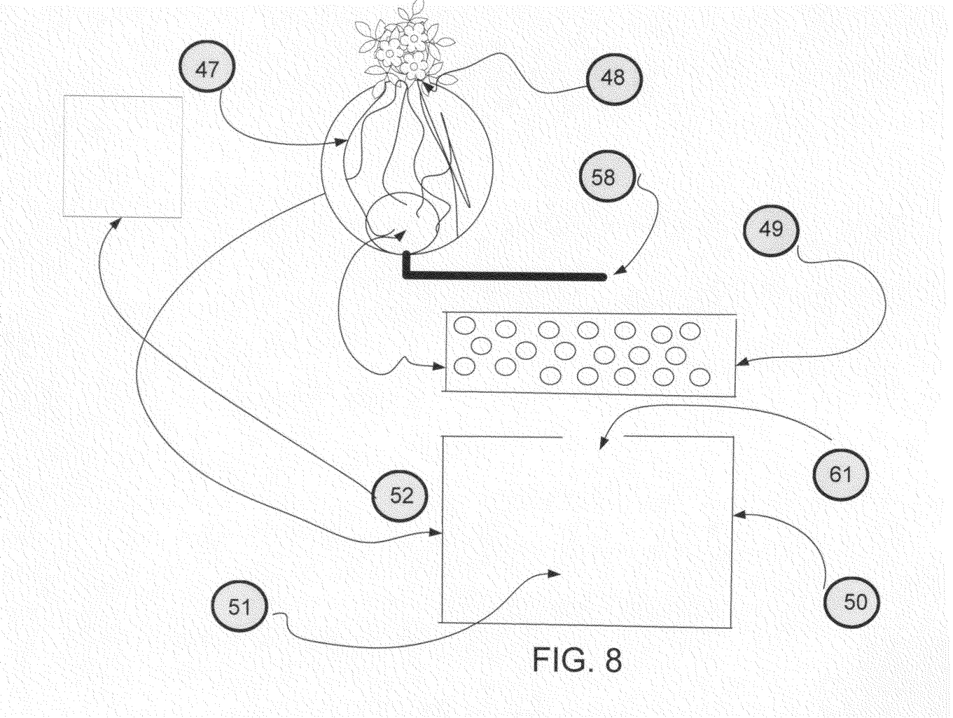

47—FIG. 8 Plants will grow inside the tube

48—FIG. 8 Plant will grow on the outside of the tube

49—FIG. 8 There is a tube place inside the container with wholes, that will allow for the irrigated water to drain to the bottom of the container. Once the irrigated water reaches the bottom the water will be reclaimed. The wholes in the tube will allow for the roots to be air pruned that will create additional root growth.

50—FIG. 8 there are removable caps at the end of the container to place growing soil or medium.

51—FIG. 8 removable top to place soil and to place plants

52 FIG. 8 Side of the container

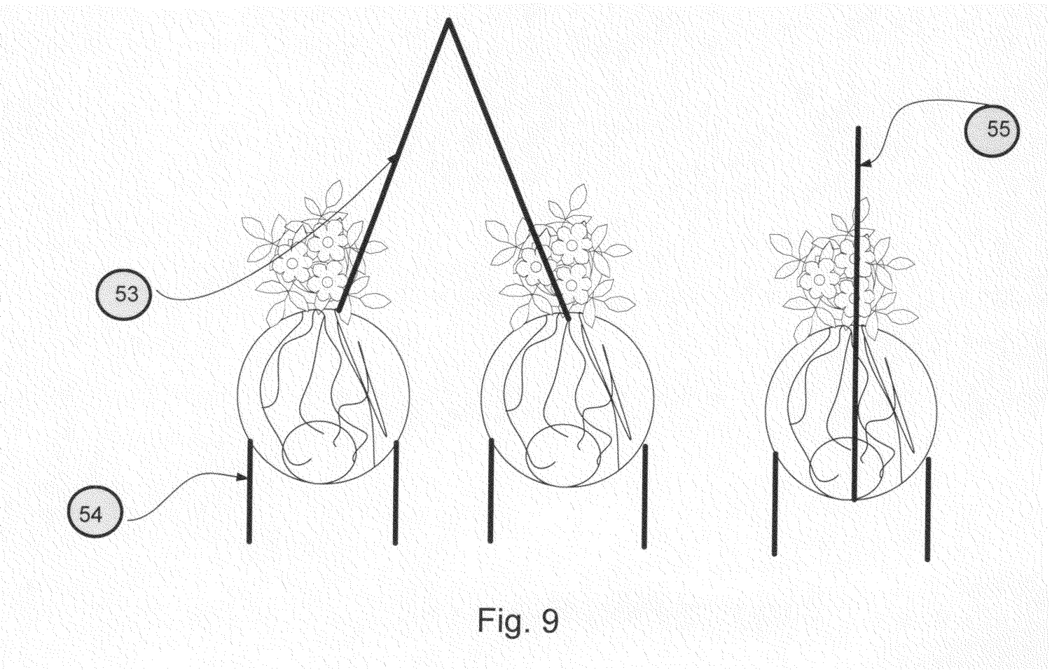

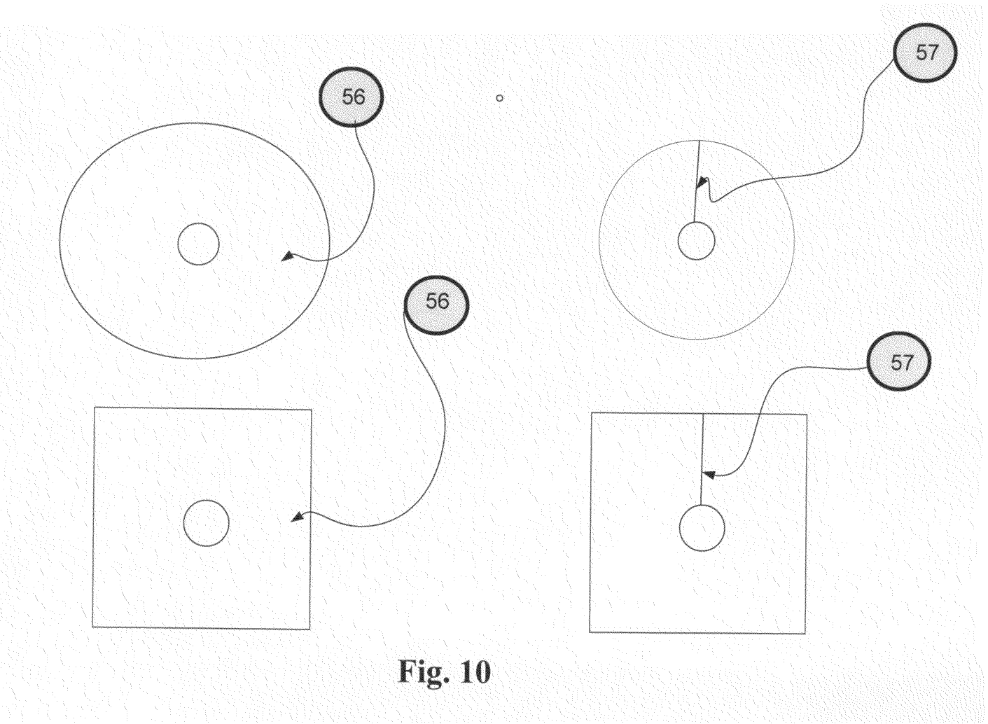

53—FIG. 9 growing stakes can be connected together to allow plant to grow

54 FIG. 9 Container can be place on a stand and be elevated above the ground

55—FIG. 9 signal growing poles can be placed inside the container for allowing the plants to grow.

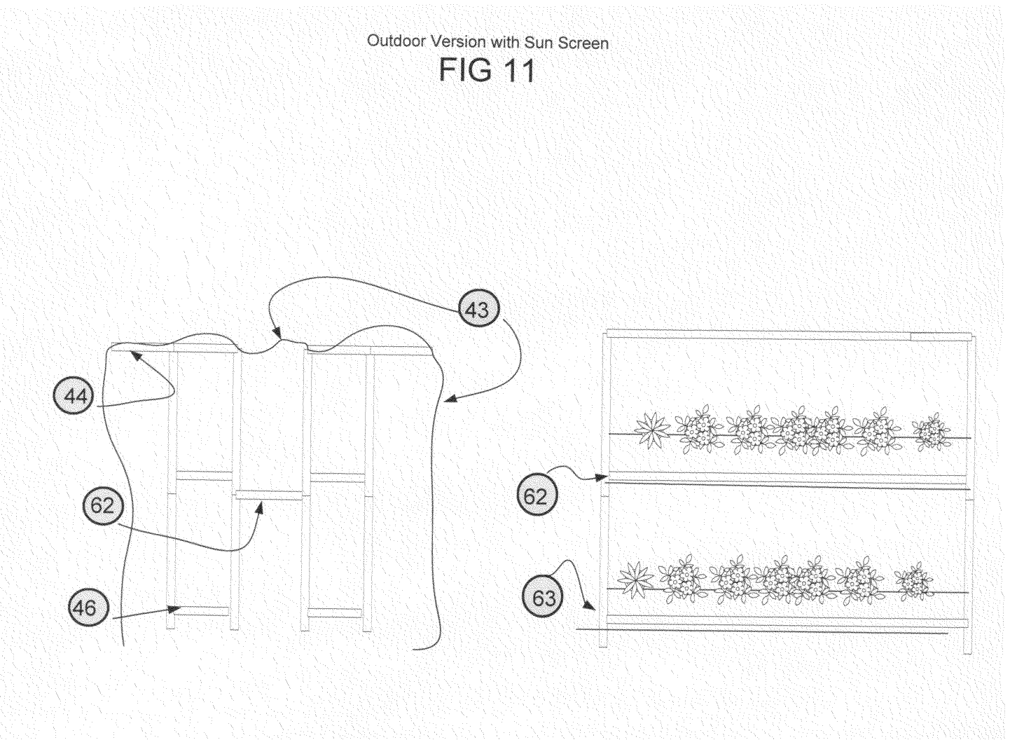

56—FIG. 10 weed ground cover will be placed on the soil round the base of the plant to prevent weeds from growing. The weed cover will be placed over the plant

57—FIG. 10 weed ground cover will be placed on the soil round the base of the plant to prevent weeds from growing. The weed cover will have a cut to the center that will allow for the weed cover to be placed around the plant.

58—FIG. 3 Support beam to support the structure and the plants that hang from it

59—FIG. 10 Liquid reclaim tube, this is where the exces liquids are reclaimed for reuse

60—FIG. 10 Internal drainage system and root pruning system, this allows for the excess water to drain from the soil and to prevent root rot.

61—FIG. 10 Opening in the plant growing tube, this is where the plant is planted. Drip irrigation may also be placed in this opening. Soil and plant nutriment may also be placed in this opening.

62—FIG. 11 this is a walk way for the 2^{nd} and N levels of the plant growing system. This is connect the 2 plant systems that add to the stability and allows for works to work on plant on the 2^{nd} through N levels.

63—FIG. 11 the base level of the plant growing system.

### DETAILED DESCRIPTION OF PREFERRED A EMBODIMENT

### Plant Growing Systems Components and How They Connect

### Growing with the Signal Post System

FIG. 3 The PLANT, VEGETABLE AND HERB GROWING SYSTEM has a signal post system to grow up to N plants in a 1×1 area or as large as needed. The system may be stacked and a walk way will be created when systems are configured side by side. The structure will have from 1 to N support beams with poles connecting the 2 support beam where the plant hang from. Structure will support from 1 to N to hang plants blocked in 58 FIG. 3. The system can adjustable ultra violet “UV” rays with adjustable and removable UV screen. The UV screen will also decrease the temperature inside the plant growing system. The UV netting will also keep insects from attacking the plants as blocked in 24 FIG. 3.

### Growing with the Multi Post System

FIG. 1 The PLANT, VEGETABLE AND HERB GROWING SYSTEM has a Multi vertical post system to hang up to N plants on the support beams that are connected to the 2 Vertical Support Post. The example in FIG. 1 has x plant containers hanging from the horizontal support beams. Each horizontal beam can support from 1 to N plants, vegetable and herbs in a 4×4 to a N×N area as needed. The systems can be placed side by side and a walk way can be placed for a second and Nth level. Structure will have from 1 to N support beams. Vertical beams will connect the 2 support beams blocked in 22—FIG. 1. Structure will support from 1 to N to hang plants blocked 23—FIG. 1. Wrap around fine netting will keep insects, animals out of the plants or Green House cover for winter growing. Water filled black blatted will release heat at night. This black blatter will take in the sun light all days and store the heat in the water and during night fall the heat from the black blatter will be released blocked in 43—FIG. 1.

### Growing with the Modular Tubing System

FIG. 8 the system can be connected form 1 to N. there are caps to be place at the end of the system. The system can be built with corrugated material that will allow for it to be flexible. The system. The system reclaim FIG. 58 allows for the liquids to be reclaimed. These tubes may be connected to make the system from 1 to N length. There is an internal drainage tube in the container. This prevents root rot and allows for the root to be air pruned. These drainage tube maybe connected together to from 1 to N.

### Space Requirements is Solved with a Vertical Growing System

PLANT, VEGETABLE AND HERB GROWING SYSTEM allows for plant to grow vertically on their porch or balcony or in their yard. The PLANT, VEGETABLE AND HERB GROWING SYSTEM can be used for commercial farming as well allowing for a 1 to N additional yield per acre for growing crops, The systems can be connected side by side and stacked. The PLANT, VEGETABLE AND HERB GROWING SYSTEM is a compact system allowing the users to grow plants up to N feet tall hanging from support beams blocked in 22—FIG. 1.

### Outdoor Use

The PLANT, VEGETABLE AND HERB GROWING SYSTEM is designed for vertical and horizontal expansion and can be configured in a vertical build to N high. When stacked side by side a walk way for the second and N th levels is created. This system will allow for maximum utilization of space to grow plants. The VERTICAL PLANT, VEGETABLE AND HERB GROWING SYSTEM can grow plant, vegetables and herbs year round, regardless of season, free of pesticides and fertilizers and eliminates weeding. The plant system will allow the user to regulate the Ultra Violet rays off of their plants from filtering from 1% to N%. The FIG. 1 example has 4 support legs and 2 beams at the top and 2 beams to hang plants below. This example would have a total of 16 hanging plants. This example would have a 4 ft×8 ft base the system is expandable to N×Y, The user will be able to use the bench to grow the plants in the cell flats or starter plant trays for the next growing season. The bench may also be used to support the vines from the vegetable growth for such variables as watermelons and cantaloupes.

### Grow Plants Year Round Inside your Own Building

The plant growing system may also be used indoors with plant growing lights and cooling fans. The indoor system requires reflective panel to retain growing light energy. For indoor use the system has a plant growing light with cooling fans and a reflective wrapper to contain the artificial sunlight FIG. 2. The PGS can work indoors with a plant light or outside in a green house during the cold winters or hot summers. The netting system will keep the insects and other animals away from the plants. The system will support the use of Hydroponics plant growing. This automatic soil monitoring system may transmit the soil condition wireless to a remote Computer work station. A web cam may also be mounted so the user can watch his plants grow remotely

### Seeding Methodology—FIG. 5

The plant growing system allows flats to be grown from the bench. By using cell flats blocked in 11—FIG. 5 or in the Manure based cells 2—FIG. 5 or in the wood and peat moss based pots or cells this help the plant to start the growth in a controlled environment. Once the plant root system is established the plant can be transplanted in whole or just the roots and soil into the plant container. Plants seeds can be started in cell flats or pots with plant soil that are from ½×½ inch to N×N size. The pots are filled with soil. The seed will be placed on the surface to N inches deep. Once the plant is large enough in the cell flat or pot they are transplanted into the plant Container Apparatus. A biodegradable cloth or screen placed around the root of the plant to keep the soil and nutrients and worms from falling out.

### Container Expansion System

The PLANT, VEGETABLE AND HERB GROWING SYSTEM has multi-plant containers. Initial system configuration is X size and contain # of containers. Containers can be added (1 to N) depending on available space. Space requirement are from 1 foot X 1 foot to N foot XX foot in FIG. 1.

### Multi Plant Container System

The hanging Container Apparatus FIG. 4—. The whole plant grows from one whole that makes it easy to prune the plant and pick the fruits and vegetables and herbs blocked in 8—FIG. 4 The plant Container Apparatus allows for multiple plant to be grown in the same space. Plant Container Apparatus can house from 1 to N plants, vegetables and herbs. The dividing walls will allow the same plant family or different plants to be grown in the same container. Worm will be placed inside the plant container and will be able to travel though small holes on the divider or in the solid divider the worms will be able to climb from one side of the divider wall to the other. Each Container Apparatus can have from 1 to N plants growing in it FIG. 4. Inside the plant Container Apparatus there are dividers separating the plants thus allowing the same plant family or different plant, vegetable and herb family to reside in the same compact space as well as different plant and vegetable families. The plant divider in the plant container make it easy to rotate the vegetables from season to season to the next growing silo with out having to empty all of the soil from the container blocked in 9 FIG. 4. Plant Container Apparatus have a dividing wall to allow plant families to be separated this will allow for better plant growth. 12 FIG. 4—Plant Container Apparatus has a hole on the side of the Container Apparatus and bottom for the plant to grow from allowing for the plant Container Apparatus to be stacked up vertically to maximum the growing space per cubic foot. The there are small hole on the lid with screening to keep the worms from escaping

The plant Container Apparatus may or may not have a handle that will allow it to be hung from the systems support beam or hung independent to the plant growing system. The plant container may be places on the bench where no handle is required blocked in 17—FIG. 4. System allow for the plant to grow from the side and bottom of the plant Container Apparatus. The plant container has a lid to with holes to keep the worms inside the plant container. The lid will prevent weeds from growing. Their will be screening to keep the worms from escaping. Plant container will have a fine mesh netting lined inside to cover the water drain holes to prevent the worms from escaping. The bottom of the container will have a drainage pipe to capture excess water. The containers will be connected via pipes and the excess water will flow to a reservoir to be reused. Plant containers lid will have a fine screen netting lined inside the lid to cover the air and water hole to prevent the worms from escaping. This screening will also block the sun light and prevent the weeds from growing.

Plant containers will have a bio degradable cloth placed around the plant base that is planted in soil. The tubular container may haveend

### Easy Crop Rotation #112—FIG. 4

Once the vegetables and herbs have produced their crop, the plant, vegetable or herb plant is pulled out and placed back in the top of the plant container to produce compost and food for the worms. The plant container has dividing walls to separate the plant growth to allow for crop rotation in the same plant container by planting the new vegetable or herb in the next hole opening

### Crop Rotation in the Plant Container FIG. 4 Plant container

The plant container has dividing walls to separate the plant growth this allows for crop rotation in the same plant container by planting the new vegetable or herb in the next hole over.

### Ease of Use with No Weeding FIG. 4

The plant, vegetable and herbs Container Apparatus allow for the plants to grow from the sides of the Container Apparatus out of a hole thus minimizing the number of weeds to pull #8—FIG. 4. By having the cloth or screen placed around the root of the plant this will restrict the weeds from growing though the screen or cloth.

Maximize the number of plants growing in a signal container #8—FIG. 4. you can grow from 1 to N in the plant container

### Adaptable Irrigation Filtration System

The PLANT, VEGETABLE AND HERB GROWING SYSTEM can utilize several different irrigation filtration systems #13—FIG. 1. The irrigation filtration system is easily adaptable for spray #13—FIG. 1, drip, pot stake, mirco sprinklers or in-ground irrigation and can operate manually, work on a timer, or with an automatic control system that will turn the irrigation system on automatically based on the soil and atmospheric conditions #14—FIG. 1. The Plant growing system will eliminate the need for the user to manually water their plants and vegetables.

15 FIG. 2—Irrigation with a water reservoir for using inside or where there is no water supply available outdoors this is important for the remote villages. Water is reclaimed from the holes in the bottom on the containers.

26 FIG. 1—The irrigation system will have a filter on it to remove any bacteria or other chemical that may be harmful to the plants, vegetables and herbs. Irrigation mist will reduce tempter for plant to grow out of season or in different claimants, the mist working with the UV sun screen will assist in lowering the temperature inside the plant growing system.

### Plant Growing System Irrigation System

13 FIG. 1—The plant growing system will have a irrigation dip system that will allow for a regulated amount of water to each plant family. The irrigation system will have a filter on it to remove any bacteria or other chemical that may be harmful to the plants, vegetables and herbs. The irrigation system will allow for water and nutrients to be efficiently applied and will conserver water. The irrigation system will apply water only to the plant container Apparatus. The irrigation system will allow for water conservation by only dispensing water as needed to each plant

15 FIG. 2—The plant growing system has an independent water reservoir to irrigate the plant on a drip bases. The plant system has a nutrient reservoir to inject plant, vegetable and herb nutrients into the plant Container Apparatus. Standard garden hose can be connected to the PLANT, VEGETABLE AND HERB GROWING SYSTEM or can be connected directly to city water or to a pump. The Irrigation mist will reduce tempter for plant to grow out of season or in different claimants. Time placed on the garden hose or on the pump to irrigate the plant containers during specific time of the day or week. Hydroponic systems will be connected to the fish tank to recycle water. Hydroponic systems will provide the nutrients from the fish by product to provide addition nutrients

### Built in Pest Control #24—FIG. 1

The PLANT, VEGETABLE AND HERB GROWING SYSTEM Minimizes the number of insects that can attack the plants by allowing them to only have between 1 to N points of entry form the support legs, this support legs are protected by motes that can be filled with insect repellent and wrapper around the support beams, therefore reducing pesticides and chemicals penetrating food source. Minimize the number of insects that will attack your plants. Plant Container Apparatus that are hung will allow for the vines to grow down and the plant leaves or vegetables and herbs to grow down ware. Block 20 FIG. 1—There is a mote on the support beans post near the ground that can be filled with pesticides to prevent insect climbing up to the plants, vegetable and herbs. This will eliminate the need to spray pesticides on the plants. Block 20 FIG. 1—The plant system will have monitor and trap for insect pests these devices will be placed around the support polls. The sticky traps attract insects by color. Hang the trap lure inside to monitor and trap these pests. Trap remains sticky all season, even in rain, or until completely coated with insects or dust. The hanging plant Container Apparatus prevents incest from climbing form the ground to spoil the plant, vegetables and herbs. The plant growing system stops the insects from attacking the plants by having the oil based or pesticide based mote around the support beam from 1 to N support beams, their will be a wrap around pest strip for the support beam to stop the intrusion on insect. The system is elevated off of the ground and is supported with 1 to N support legs. FIGS. 1, 2 and 3. The support legs have and pesticide strip that wraps around the support leg preventing bugs and insects from climbing up the support beam to attract the plants, herbs and vegetables Block 20—FIG. 1. There is a second security system for insects that is an oil-based mote that surrounds the support legs that will prevent insects from climbing to the plants, herbs and vegetables. By keeping the insects off of the vegetables and herbs there is no need to spray the plant with harmful pesticides #19—FIG. 1. Netting around the PLANT, VEGETABLE AND HERB GROWING SYSTEM will minimize the number of animals that will attack your plants. To Protect the worm farm system the legs have a pesticide mote and sticky strips to protect the worms. The netting around the system will keep the birds and other animals away from eating the plant and vegetables. Control monitoring system for the soil and nutrient will assist the user on how their plants and vegetables are doing and their condition this netting still allow for the sin and rain to penetrate the plants #23—FIG. 1.

### Protect you Plant From the Hot Sun and Grow Plants out of Season

### Temperature Control for Growing Plants out of Season

To control the outside temperature there is a sun screen or UV ray cover will allows the user to adjust mow much sunlight that plants will receive this will allow for plants and vegetables to be grown out of season. The UV ray cover will drop the outside tempter. The system will have a mist system that will also assist in dropping the outside tempter. By dropping the outside temperature with the mist this will allow the user to grow plant, vegetables and herbs out of the normal seasons. The system will allow for multi vegetables, herbs and plant to be grown in the same Container Apparatus with the same soil and irrigation system #8—FIG. 4. The drip, pot stake, micro sprinklers irrigation allows for a controlled amount of water to be feed to the plants and vegetable and herbs and conserve water and plant and vegetable nutrients. When the system is used indoors there is a pan that will fit under the bench to catch the excess water from hitting the flooring. The plant growing system will allow plant to be watered with an irrigation system with a timer or with out a timer. The irrigation will allow for plant and vegetable and herb fertilizer, plant food, or other nutrients to be injected into the irrigation system. The Irrigation system will allow for a spray, drip inside the plant container. The system will work out doors with or with out an ultraviolet ray screen that will filter the sun light up to 95%.

### How the Plant Growing System is Different from Anything that Currently Exists

There is no system that allows for multiple plants to grow in the same container and to hang multiple plants from the structure that is protected from insects. The system has a pest control mote and sticky strips at the base of the legs to preventing incest from attacking the plants. This plant system allows for the user to easily maintain a high yielding garden per cubic foot used. The plant containers have a drainage hole for the excess water for flow to a reservoir. The excess water can be reclaimed and used. With the timer based irrigation system for feeding the plants on a scheduled basis. The systems can be connected side by side and walk ways can be created that will allow the a person to work on the 2^{nd} and Nth levels of the system. There is a worm farm built into system that will produce worms, nutrients, and compost to the plants and vegetables healthy. The worms grown in the worm farm will be placed in the plant containers to cultivate the root system of the plant, vegetables and herbs. The system has a built in composting and worm farm there is no closed loop system that make it easy to grow plant, vegetables and herbs. With the built in Ultra Violet screen this will prevent the plant, vegetables and herbs from being burnt. The UV screen will also allow plant vegetables and herbs to be grown out of season. The UV screen will prevent insects from attacking the plants.

### Control Module Monitors Soil Conditions

The control module (CM) is designed to eliminate the need to manually test the soil conditions of your plants and what the atmosphere conditions and can identify if the soil is getting too much or too little water and other nutrients. CMS applies water and nutrients as needed to keep the balance for optimal growth and is powered by photo cells, battery or standard household electric. The CMS receives data and is transmitted and stored in a central database and tracked by sensor for analysis of the health of the plant and to determine the crop yield. The system will have a webcam that will allow the user to watch their plants grow remotely.

### Plant Vegetable and Herb Growing Systems Operation

The system solves the growing space problem by allowing the users to grow plants up to N feet tall hanging from support beams. The plant, vegetable and herbs Container Apparatus allow for the plants to grow from the sides of the Container Apparatus. Each Container Apparatus can have from 1 to N plants growing in it. Inside the plant Container Apparatus there are dividers separating the plants, vegetable and herbs thus allowing the same plant family or different plant, vegetable and herb family to reside in the same compact space as well as different plant and vegetable families. The irrigation system will allow for water and nutrients to be efficiently applied to conserver water and plant, veritable and herbs nutrients to the plant Container Apparatus. The plant growing system pest control system stops the incest from attacking the plants by having the oil based or pesticide based mote around the support beam post from 1 to N support beams post, their will be a wrap around pest strip for the support beam to stop the intrusion on insect. To control the outside temperature there is a UV ray cover will allows the user to adjust mow much sunlight that plants will receive this will allow for plants and vegetables to be grown out of season. The UV ray cover will drop the outside temperature. The system will have a mist system that will also assist in dropping the outside tempter. By dropping the outside temperature this will allow the user to grow plant, vegetables and herbs out of the normal seasons. The netting around the system will keep the birds and other animals away from eating the plant and vegetables. Control monitoring system for the soil and nutrient will assist the user on how their plants and vegetables are doing and their condition. The system will allow for multi vegetables, herbs and plant to be grown in the same Container Apparatus with the same soil and irrigation system. The worm and compost farm that is housed under the bench will allow for food to be recycled and will provide high nutrients for the plant and vegetables. The plant Container Apparatus are designed to grow multiple plant per bucket. The worms in the plant container can be feed that is rotten or the table scraps and old newspaper or old paper. The drip, pot stake, micro sprinklers irrigation allows for a controlled amount of water to be feed to the plants and vegetable and herbs and conserve water and plant and vegetable nutrients. When the system is used indoors there is a pan that will fit under the bench to catch the excess water from hitting the flooring. The plant growing system will allow plant to be watered with an irrigation system with a timer or with out a timer. The irrigation will allow for plant and vegetable and herb fertilizer, plant food, or other nutrients to be injected into the irrigation system. The Irrigation system will allow for a spray, drip. The plant system can work indoors with a plant light or outside in a green house during the cold winters or during the hot summers. The system will work out doors with or with out an ultraviolet ray screen that will filter the sun light up to 95%. There is a netting system that will keep the birds and other animals away from destroying the plants, herbs and vegetables. The system is elevated off of the ground and is supported with 1 to N support legs. The support legs have and pesticide strip that wraps around the support leg preventing bugs and incest form climbing up the support beam to attract the plants, herbs and vegetables. There is a second security system for incest that is a oil based mote that surrounds the support legs that will prevent incest from climbing to the plants, herbs and vegetables. The planting system will allow the user to grow Hydroponics plant. The system solves the growing space problem by allowing the users to grow plants vertical up to N feet tall hanging from support beams. The plant, vegetable and herbs Container Apparatus allow for the plants to grow from the sides of the Container Apparatus. Each Container Apparatus can have from 1 to N plants growing in it. Inside the plant Container Apparatus there are dividers separating the plants, vegetable and herbs thus allowing the same plant family or different plant, vegetable and herb family to reside in the same compact space as well as different plant and vegetable families. The irrigation reservoir system will allow for water and nutrients to be efficiently applied to conserver water and plant, veritable and herbs nutrients to the plant Container Apparatus. The plant growing system stops the incest from attacking the plants by having the oil based or pesticide based mote around the support beam from 1 to N support beams, there will be a wrap around pest strip for the support beam to stop the intrusion on insect. To control the outside tempter there is a UV ray cover will allows the user to adjust mow much sunlight that plants will receive this will allow for plants and vegetables to be grown out of season. The UV ray cover will drop the outside tempter. The system will have a mist system that will also assist in dropping the outside tempter. By dropping the outside tempter this will allow the user to grow plant, vegetables and herbs out of the normal seasons. The netting around the system will keep the birds and other animals away from eating the plant and vegetables. Control monitoring system for the soil and nutrient will assist the user on how their plants and vegetables are doing and their condition. The system will allow for multi vegetables, herbs and plant to be grown in the same Container Apparatus with the same soil and irrigation system. The container will have dividers so the same plant family or different plant families can grow in the same container. The divider may or may not have holes to let the worms move from one part of the container to the other. The goal with the plant divider is to separate the plant roots and to allow the worms to cultivate all of the plants. Plant container will have a fine mesh netting lined inside to cover the water drain holes to prevent the worms from escaping. Plant container will have a fine screen netting lined inside to cover the water drain holes to prevent the worms from escaping. Plant containers will have a fine mesh netting to be placed around the plant base that is planted in soil. This mesh netting will hold the soil in and prevent the worms from escaping. Plant containers will have a fine mesh netting to be placed around the plant base that is planted in soil. This screen netting will hold the soil in and prevent the worms from escaping. Plant containers will have a bio degradable cloth or screen placed around the plant base root of the plant that is planted in soil. This screen netting will hold the soil in and prevent the worms from escaping. The irrigation system will have a filter on it to remove any bacteria or other chemical that may be harmful to the plants, vegetables and herbs. The drip, pot stake, micro sprinklers irrigation allows for a controlled amount of water to be feed to the plants and vegetable and herbs and conserve water and plant and vegetable nutrients. When the system is used indoors there is a pan that will fit under the bench to catch the excess water from hitting the flooring. The plant growing system will allow plants to be watered with an irrigation system with a timer or with out a timer. The irrigation reservoir system will allow for plant and vegetable and herb fertilizer, plant food, or other nutrients to be injected into the irrigation system. The Irrigation system will allow for a spray, drip.

#340 The plant system can work indoors with a plant light or outside in a green house during the cold winters or during the hot summers. The system will work out doors with or without an ultraviolet ray screen that will filter the sun light up to 95%. There is a netting system that will keep the birds and other animals away from destroying the plants, herbs and vegetables.

The system is elevated off of the ground and is supported with 1 to N support legs. The support legs have and pesticide strip that wraps around the support leg preventing bugs and incest form climbing up the support beam to attract the plants, herbs and vegetables. There is a second security system for incest that is a oil based mote that surrounds the support legs that will prevent incest from climbing to the plants, herbs and vegetables. The planting system will allow the user to grow. The system will support the use of Hydroponics plant growing. This automatic soil monitoring system may transmit the soil condition wireless to a remote Computer work station. A web cam may also be mounted so the user can watch his plants grow remotely. The worm and compost farm that is housed under the bench will allow for food to be recycled and will provide high nutrients for the plant and vegetables. The plant Container Apparatus is designed to utilize the worm tea, compost and liquid fertilizer know as leachate that is a bi product of the worm farm. Worm farming tub will provide casting to be provided to the plants as additional nutrients. Worm farm will allow the user to recycle their vegetables and other foods. Worm Collection and holding tray for liquid fertilizer know as leachate or worm tea. Worm Drain Pipe for liquid fertilizer know as leachate or worm tea and a Base legs with Pesticide mote and sticky strips to protect the worms. Bee hive will be used for the pollination of the plants. Having a bee hive close to the plant growing system will help in the pollination of the plant, vegetables and herbs. Bee will stimulate the growth and productivity of the plants, vegetables and herbs. The bee hive will produce honey and bees wax. There is an automatic soil monitoring system may transmit the soil condition wireless to a remote Computer work station. A web cam may also be mounted so the user can watch his plants grow remotely

### ALTERNATIVE EMBODIMENTS

Plant container can be used as stand alone. The hanging plant Container Apparatus prevents incest from climbing form the ground to spoil the plant, vegetables and herbs. The plant Container Apparatus allow for multiple plant to be grown in the same space. Plant Container Apparatus have a dividing wall to allow multiple plant families or the same plant family to grow in the same plant container and for the plants grow in their own soil. Plant Container Apparatus can house from 1 to N plants, vegetables and herbs. Plant Container Apparatus has a hole on the side of the Container Apparatus and bottom for the plant to grow from allowing for the plant Container Apparatus to be stacked up vertically to maximum the growing space per cubic foot. The plant growing system will have a irrigation dip system that will allow for a regulated amount of water to each plant family. Some plants may require more watering than other in the same plant container. The irrigation system will allow for water conservation by only dispensing water as needed to each plant. The plant growing system has an independent water reservoir to irrigate the plant on a drip bases. The plant system has a nutrient reservoir to inject plant, vegetable and herb nutrients into the plant Container Apparatus. The plant Container Apparatus will have handle that will allow it to be hung from the systems support beam or hung independent to the plant growing system. System allow for the plant to grow from the side and bottom of the plant Container Apparatus. Plant containers have mesh screening to contain the worm from escaping Plant container will have fine mesh netting lined inside to cover the water drain holes to prevent the worms from escaping. The PGS pest control mote system is at the base of the system that can be filled with pesticides to prevent incest from climbing the support beam and attacking the plant. Plant container divider will allow multiple plant families can grow in the same plant container from 1 to N plants. Plant container divider will let the same plant family grow in the same plant container from 1 to N plants. The vertical plant growing system allow the user to grow more Vegetables and Herbs per cubic foot. Worms for the composting is import to have good soil conditions that promotes healthy plants. Worms are ecological beneficial, they eat the table scraps and used news paper and cardboard. As a result there is less waste going into land fills. The worms and compost farm is housed under the bench or in a stand alone box. This devise will allow for food to be recycled and will provide high nutrients for the plant and vegetables. The worm farm will produce worm tea and liquid fertilizer know as leachate. The worm farm will producer worm casting that will be sprinkled on the surface of the soil around your plants and booster in water. Fruits and vegetables not only grow faster, but are also better tasting and healthier than chemical plants, which can be bitter due to salts that are present in most chemical fertilizers. Worm Casting allow for better growth of plants, vegetables and herbs and are less likely to succumb to pest and diseases. Worm from the worm farm bin will be placed in the plant container to assist in the federalization process of the plant. Worm Tea (from Spigot) this will promote plant growth. Worm leachate for plant, vegetable and herb nutrients. The worm grown in the worms farm can be for resell as well as use in the plant containers. Compost for growing plants for plant, vegetable and herb nutrients. Honey from the bee hive can be consumed or sold. The Bee Hive will have an oil based or pesticide mote on the legs or support beams of the bee hive to keep the ants from attacking the Bee Hive for the honey. Bee from the bee hive to pollinate all of the plant, vegetables and herbs. Fish tank water filtered thought the plant system and reclaimed and returned to the fish tank with the nutrients used for the hydroponic plants providing for a closed loop system. Mesh netting to wrap around the Plant growing system to prevent animals from eating the vegetables and herbs. There is a mote on the support beans near the ground that can be filled with pesticides to prevent insect climbing up to the plants, vegetable and herbs. This will eliminate the need to spray pesticides on the plants. The plant system will have monitors and trap for insect pests these devices will be placed around the support polls. The sticky traps attract insects by color. Hang the trap lure inside to monitor and trap these pests. Trap remains sticky all season, even in rain, or until completely coated with insects or dust.

What is claimed is:

1. The Container Apparatus allows for multiple plants to grow from the sides or from the top of the Container Apparatus out of a hole thus minimizing the number of weeds to pull. Multiple plant can be grown in each container.
Additional claims that support claim 1
a.) The Container Apparatus can vary in length and may be flexible.
b.) This allow for the weeds to be easy identified.
c.) Material will be placed on top of the container that blocks sun light and allows water though to water the plant and a small hole for the plant to grow through.
d.) Weed cover material will block weeds from growing through the material placed on the top of'the Container Apparatus. The container apparatus will allow for irrigation to be placed in the whole where the plant grows from.

2. Plant Growing System Apparatus with multiple levels. The System will allow for multiple levels with artificial lighting to help stimulate plant growth.
Additional claims that support claim 2
a.) This system will allow for a walk way to be created between systems.
b.) This walk way on the 2^{nd} and Nth level will allow for the maintenance of the plants.
c.) This Apparatus will allow for sunscreen to be placed on the top to regulate the amount of the sunlight.
d.) The Apparatus will system will allow for netting to be placed on the exterior to prevent insects from attacking the plants. The system will allow a mist to be sprayed from the top of the system and a capture apparatus on the bottom of the system to recapture the water.

3. Container Apparatus will recapture the water from the drip irrigation system. At the bottom of the container there is a whole that tubing or piping may be connected.
Additional claims that support claim 3
a.) This water will be piped into a water reservoir and can be recycled to the container apparatus.
b.) The is multiple outlets for the irrigated water to drain out to
c.) There is an internal pipe with hole to allow the plant roots to air prune and the water to drain,
